(19) United States
(12) Patent Application Publication
(10) Pub. No.: US 2014/0252782 A1
(43) Pub. Date: Sep. 11, 2014

(54) DOOR OPERATOR

(71) Applicant: Alexander HELLWIG, Ennepetal (DE)

(72) Inventor: Alexander HELLWIG, Ennepetal (DE)

(73) Assignee: Dorma GmbH + Co. KG

(21) Appl. No.: 14/200,974

(22) Filed: Mar. 7, 2014

(30) Foreign Application Priority Data
Mar. 8, 2013 (DE) DE102013102337.1

(51) Int. Cl. E05F 1/10

(52) U.S. Cl. CPC E05F 1/10
USPC 292/173; 292/143

(57) ABSTRACT

A door operator includes a housing, a sliding element, supported within the housing and translationally movable along a first axis, an output shaft, rotatably movable about a second axis, and a transmission element, which is adapted to mutually convert a rotational movement of the output shaft into a translational movement of the sliding element. The transmission element includes a rotation element, which can be driven by the output shaft, and includes a lever, which is attached to the sliding element and eccentrically attached to the rotation element

### BACKGROUND OF THE INVENTION

1. Field of the Invention

The present invention relates to a door operator for opening and/or for closing a door leaf.

2. Description of the Related Art

Various types of door operators are known from the state-of-the-art. Included are in particular door closers, servo-assisted door closers or door drives. A door operator is typically attached either directly to the door leaf or to the wall or to the casing. If the door operator is located at the wall or at the casing, an output shaft of the door operator is connected to the door leaf via an arm assembly. If the door operator is located at the door leaf, the arm assembly connects the output shaft to the wall or to the casing. Within the door operator, the rotation of the output shaft is changed into a linear movement of a sliding element, such that, on account of the linear movement, energy is stored in an energy accumulator. The energy accumulator is able to deliver the energy back to the sliding element, which performs another linear movement opposite to the previously mentioned linear movement. The output shaft is driven in this way, so that, for example the door leaf can be closed or opened.

### SUMMARY OF THE INVENTION

It is an object of the present invention to provide a door operator, which, while being simple and inexpensive in manufacturing and mounting, allows for actuating a door leaf of a door in a reliable and low-maintenance manner.

A solution of this problem is realized according to a first aspect of the present invention, by a door operator comprising a housing and an output shaft, which is supported in the housing, in particular to be rotatably movable. The output shaft is rotatably movable about a second axis. Furthermore, the door operator comprises a sliding element, which is supported within the housing and translationally movable along a first axis. The sliding element may be in particular a piston. The movement of the sliding element and the movement of the output shaft are coupled via a transmission element. The transmission element is adapted to mutually convert a rotational movement of the output shaft into a translational movement of the sliding element. According to an aspect of the invention, the transmission element comprises a rotation element, which can be driven by the output shaft. Furthermore, a lever is provided, which is eccentrically disposed at the rotation element, the lever connecting the rotation element to the sliding element. By virtue of the lever being attached to the sliding element and being eccentrically disposed at the rotation element, the lever is therefore able to convert a rotational movement of the rotation element into a translational movement of the sliding element. Therefore, altogether the output shaft is able to change a rotational movement of a door into a translational movement of the sliding element, wherein in the reverse case, i.e. a conversion of a translational movement of the sliding element into a rotational movement of the door is likewise possible. The door operator may be located for example on the door leaf such that, via an arm assembly, the output shaft can transmit force onto a casing or onto a wall. In case the door operator is located at the wall or at the casing, the output shaft and an appropriate arm assembly transmit force onto the door leaf In addition, it is possible that the output shaft is disposed coaxially to the axis of rotation of the door, such that no additional arm assembly for transmitting the force is required. With the exemplary alternatives, the door operator is thus able to exert force onto a door leaf in order to dampen for example a movement of the door leaf and/or to automatically move the door leaf.

In one aspect of the present invention, the rotation element consists of a toothed wheel. According to another aspect, the toothed wheel is in engagement with a toothing of the output shaft. In this case, the ratio of transmission between the output shaft and the rotation element, which ultimately determines the translational movement path of the sliding element, can be adjusted by the number of teeth of the toothed wheel and the output shaft. This arrangement allows for a flexible configuration of the door operator while featuring a simple and inexpensive manufacturing and mounting. As an alternative, the rotation element can be driven by the output shaft via a friction drive or via a belt drive.

It is preferred, in another aspect, that the housing of the door operator has a low volume, which is why it is in particular intended that the lever transmits a maximum path of the rotation element onto the sliding element. Therefore, the lever is disposed in particular at a location at the rotation element at which the rotation element has the largest possible diameter. In other words, in one aspect, the lever is disposed as far away from the rotational axis of the element as possible. As a large lever travel is realized in this way between the rotational axis of the rotation element and the point of attachment of the lever, such an arrangement is likewise advantageous with regard to the transmission of force between the rotation element and the sliding element.

In accordance with one aspect of the invention, the lever is attached so as to be rotatably movable at the rotation element and/or at the sliding element. This arrangement allows for a simple manufacturing of the lever as well as an inexpensive mounting of the lever at the rotation element and at the sliding element.

In another aspect, that the axis of rotation of the rotation element runs parallel to the second axis. This means that the axis of rotation of the rotation element is configured to be parallel to the axis of rotation of the output shaft. This arrangement simplifies a transmission of force and torque between the rotation element and the output shaft. In particular when utilizing a preferably provided toothed wheel as the rotation element, this arrangement is particularly advantageous.

In an advantageous aspect, the door operator comprises, in addition, an energy accumulator, which may consist in particular of a spring. The spring is preferably a helical spring. The energy accumulator is preferably configured in that the latter is able to exert force onto the sliding element along the first axis. Thus, during a translational movement of the sliding element along the first axis, on the one hand the energy accumulator draws energy from the sliding element, in order to store the energy, and, on the other hand, the energy accumulator is able to deliver energy to the sliding element. Thus, when moving the door leaf for opening a door for example, energy can be transmitted to the energy accumulator such that the latter can deliver energy to the sliding element, in order to pivot the door leaf for closing the door. In this way, a door closer can be exemplary embodied.

Preferably, in another aspect, the sliding element is configured such that it has a hollow space. The hollow space accommodates preferably the output shaft and the transmission element, the sliding element preferably having an opening through which the output shaft protrudes from the sliding element. It is particularly preferred, in another aspect, that the sliding element has two opposite openings such that the output shaft protrudes for example through both openings from the sliding element. Such an integral construction is in particular advantageous, in order to keep the volume of the door operator particularly low. On the other hand, transmitting a force from the output shaft onto the sliding element does not require a large load displacement. In this manner, the number of employed components can be kept low, increasing the reliability of the door operator.

In one advantageous aspect, a cage is provided to accommodate the transmission element. The cage is preferably supported at the output shaft and thus allows for a linkage of the output shaft to the transmission element. The cage is in particular advantageous, if the sliding element presents the aforementioned hollow space, which accommodates the output shaft and the transmission element. In any case, the advantageously employed cage allows for pre-mounting the transmission element such that the final mounting of the door operator is realized in a very simple, quick and inexpensive manner.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will now be described in more detail, reference being made to the drawings, in which:

FIG. 1: shows a diagrammatical overview on a door operator according to an exemplary embodiment of the invention;

FIG. 2: shows the sliding element of the door operator according to the exemplary embodiment of the invention;

FIG. 3: shows another view of the sliding element of the door operator according to the exemplary embodiment of the invention; and

FIG. 4: shows the connection between the output shaft and the transmission element within the door operator according to the exemplary embodiment of the invention.

### DETAILED DESCRIPTION OF THE PRESENTLY PREFERRED EMBODIMENTS

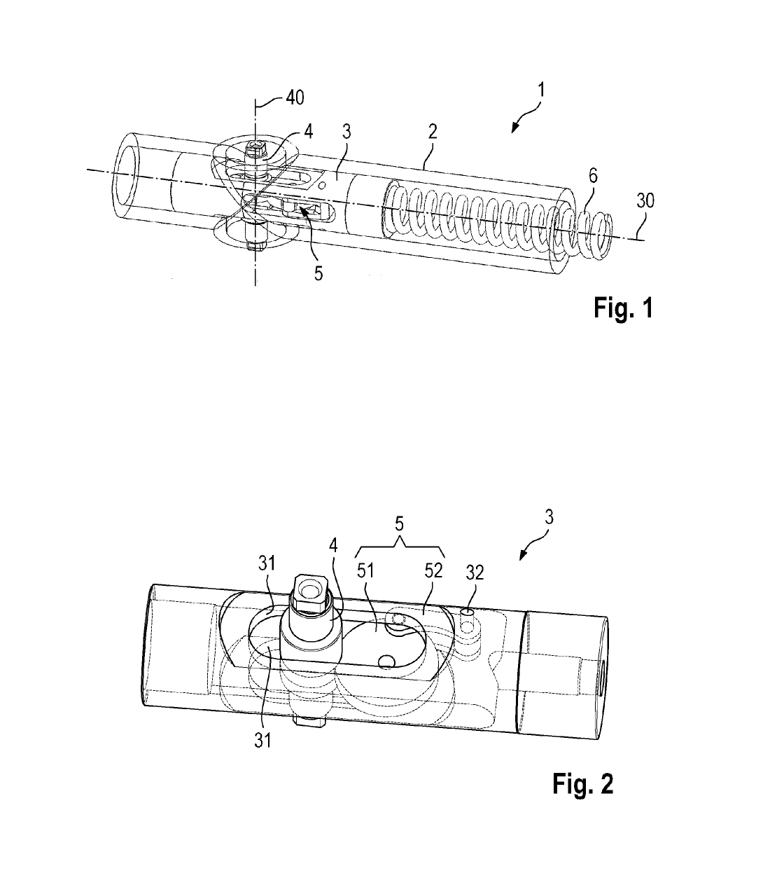

FIG. 1 shows a door operator 1 according to an exemplary embodiment of the invention. The door operator 1 comprises a housing 2, in which an output shaft 4 is rotatably supported. In this case, the output shaft 4 is rotatably movable about a second axis 40. Furthermore, the door operator 1 comprises a sliding element 3, which is rotatably movable along a first axis 30 within the housing 2. Both the housing 2 and the sliding element 3 are configured to be essentially cylindrical, the sliding element 3, in at least one partial area, abutting against the inner wall of the cylindrically shaped housing 2. An energy accumulator 6, in the shape of a helical spring, is disposed at the sliding element 3 such that the energy accumulator 6 props itself up against the sliding element 3 and against a cover (not shown) of the housing 2. In case of a translational movement of the sliding element 3 along the first axis 30, the energy accumulator 6 can be either contracted or expanded. In case of a contraction, the energy accumulator 6 stores energy in order to release the energy again by expansion.

The door operator 1 may be attached for example to a wall or to a casing, wherein the output shaft 4 exerts force onto a door leaf, in particular via an arm assembly. As an alternative, the door operator 1 may be attached to the door leaf such that the output shaft 4 exerts force onto a wall or onto a casing, in particular via an arm assembly. In addition, it is possible that the second axis 40 is disposed to be coaxial to the axis of rotation of a door such that no arm assembly at all is required for transmitting forces.

FIG. 2 shows a diagrammatical illustration of the sliding element 3. The sliding element 3 has two openings 31, which allow access to a hollow space of the sliding element 3. A transmission element 5, which comprises a rotation element 51 and a lever 52, is disposed within the hollow space. The lever 52 is eccentrically disposed at the rotation element 51 and rotatably connected to the latter. In addition, the lever 52 is rotatably connected to the sliding element 3, which is realized by a pin 32. For this purpose, the pin 32 is guided through coaxially aligned openings of the sliding element 3 and the lever 52.

By the transmission element 5, the sliding element 3 is movable in relation to the output shaft 4 because the output shaft 4 is connected to the rotation element 51 of the transmission element 5 for transmitting forces. For this purpose, the rotation element 51 is configured as a toothed wheel in engagement with a toothing of the output shaft 4. Therefore, on account of a rotation of the output shaft 4, the sliding element 3 can be displaced along the first axis 30 in relation to the output shaft 4 via the lever 52, which is moved by the rotation element 51.

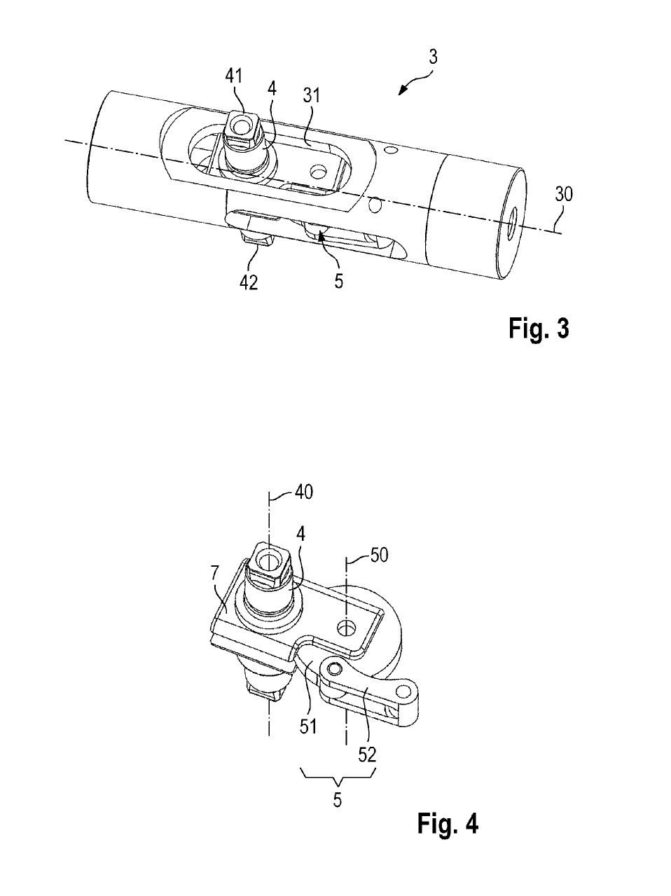

FIG. 3 shows another view of the sliding element 3. It is visible that the openings 31 have an oval shape such that the sliding element 3 can be displaced in relation to the output shaft 4. The output shaft 4 protrudes from the sliding element 3 through both openings 31 such that a linkage of the door operator 1 to a door is always possible independently of the pivoting direction of the door. This is achieved in that either a first end 41 of the output shaft 4 or a second end 42 of the output shaft 4 is utilized for the transmission of forces.

It can be further seen from FIG. 3 that the entire transmission element 5 is disposed within the sliding element 3. Therefore, the door operator 1 is constructed in a space saving manner, which is reflected in a small exterior volume of the entire door operator 1.

FIG. 4 shows in a diagrammatical way how the transmission element 5 is connected to the output shaft 4. A cage 7 is provided for this purpose, in which, on the one hand the output shaft 4 is guided and, on the other hand, the rotation element 51 is accommodated. The cage 7 is in particular configured such that an axis of rotation 50 of the rotation element 51 runs parallel to the second axis 40. The cage 7 defines furthermore a distance of the axis of rotation 50 from the second axis 40. Therefore, the position of the rotation element 51 in relation to the output shaft 4 is uniquely determined, which allows for transmitting forces and for transmitting momentum between the output shaft 4 and the rotation element 51 via a toothed wheel connection. The rotation element 51 is configured as a toothed wheel for this purpose, the output shaft 4 having a toothing which is in engagement with the toothed wheel. If the output shaft 4 is rotated, this rotation is transferred onto the rotation element 51, and the proportion of teeth between the rotation element 51 configured as a toothed wheel and the teeth of the output shaft 4 determines a ratio of transmission. This means that, via the proportion of the number of teeth, a lever travel can be determined, which the lever 52 performs during a defined movement of the output shaft 4. As the lever 52 itself is rigid and fixedly connected to the rotation element 51 and to the sliding element 3, altogether the proportion of the number of teeth determines a displacement by which, during a defined rotation of the output shaft 4, the sliding element 3 moves translationally with regard to the output shaft 4.

By virtue of the cage 7, the transmission element 5 can be very simply pre-mounted such that the latter can be disposed as a unit at low expense within the sliding element 3. As a result, mounting the door operator 1 becomes very simple and thus inexpensive. Furthermore, the pre-mounting of the transmission element 5 within the cage 7 is not prone to error. So failure of the door operator 1 on account of faulty mounting is very unlikely.

The invention is not limited with respect to its construction to the preferred embodiment example indicated in the preceding. On the contrary, there are a number of conceivable variants which can be made use of by the demonstrated solution also in fundamentally different arrangements. All of the features and/or advantages, including constructional details or spatial arrangements, stemming from the claims, the description or the drawings may be essential to the invention both by themselves and in the most widely varying combinations. Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A door operator (1), comprising:
a housing (2);
a sliding element (3) supported within the housing (2) and translationally movable with respect to the housing along a first axis (30);
an output shaft (4) rotatably movable about a second axis (40); and
a transmission element (5) configured to mutually convert a rotational movement of the output shaft (4) into a translational movement of the sliding element (3), the transmission element (5) having:
(a) a rotation element (51) drivable by the output shaft (4), and
(b) a lever (52) attached to the sliding element (3) and attached eccentrically to the rotation element (51).

2. The door operator according to claim 1, wherein output shaft (4) has a toothing, and the rotation element (51) comprises a toothed wheel engageable with the toothing of the output shaft (4).

3. The door operator according to claim 1, wherein the lever (52) is attached to the rotation element (51) at a location at which the rotation element (51) has its largest diameter.

4. The door operator according to claim 1, wherein the transmission element (5) is configured to change a rotation of the output shaft (4) into a displacement of the sliding element (3) in relation to the output shaft (4).

5. The door operator according to claim 1, wherein the lever (52) is attached to the rotation element (51) and/or to the sliding element (3) so as to be rotatably movable.

6. The door operator according to claim 1, wherein the rotation element (51) is rotatably movable about a third axis (50) that runs parallel to the second axis (40).

7. The door operator according to claim 1, further comprising an energy accumulator (6) configured to exert a force onto the sliding element (3) along the first axis (30).

8. The door operator according to claim 1, wherein the sliding element (3) defines at least one hollow space in which the output shaft (4) and the transmission element (5) are accommodated, and wherein at least one opening (31) is provided within the sliding element (3) through which the output shaft (4) protrudes from the sliding element (3).

9. The door operator according to claim 1, further comprising a cage (7) configured to accommodate the transmission element (5), the cage (7) being supported at the output shaft (4).

10. The door operator according to claim 7, wherein the energy accumulator (6) is a spring.
